(19) United States
(12) Patent Application Publication
(10) Pub. No.: US 2010/0026431 A1
(43) Pub. Date: Feb. 4, 2010

(54) MAGNETICALLY SUSPENDED GYROSCOPIC ACTUATOR DEVICE

(75) Inventor: Damien Chassoulier, Mouans-Sartoux (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/509,784

(22) Filed: Jul. 27, 2009

(30) Foreign Application Priority Data
Jul. 29, 2008 (FR) 08/04323

(51) Int. Cl. H01F 7/06

(52) U.S. Cl. 335/219

(57) ABSTRACT

The present invention relates to a magnetic suspension structure having one or two active axes, specifically suited to the wheels of gyroscopic actuators. This type of device is intended to be on board maneuvering satellites. The gyroscopic actuator enables ground testing of a gyroscopic wheel along any axis. It has a maximum of two active axes and it is capable of taking up strong transverse torques. The gyroscopic actuator includes a magnetic suspension obtained by the combination of a passive thrust and an active center finder.

### CROSS REFERENCE TO RELATED APPLICATIONS

The present application claims the benefit of French Patent Application Serial No. 08/04323, filed Jul. 29, 2008, which is hereby incorporated by reference in its entirety.

### TECHNICAL FIELD

The present invention relates to a magnetic suspension structure having one or two active axes, specifically suited to the wheels of gyroscopic actuators. This type of device is intended to be on board manoeuvring satellites.

The aim of the invention is to define new magnetic suspension architectures with which to make a magnetic bearing wheel levitate.

### BACKGROUND OF THE INVENTION

Currently, research into the field of magnetically suspended gyroscopic actuators is targeted primarily at obtaining wheels that can be tested along any axis, under gravity, without consuming additional energy. Then, for cost and complexity reasons, the aim is to have a maximum of two axes to be controlled actively. Finally, since it is required to be used in gyroscopic actuators, the wheels must have suspensions capable of taking up strong transverse torques.

The solutions currently envisaged are more often than not founded on a mechanical issue, the wheels being mounted on ball bearings. The problems encountered are conventionally problems of heating, longevity, microvibrations, etc. In the present patent application, the wheel concerned is magnetically suspended; the rotor is mounted on magnetic bearings. It relies on the use of magnets, windings, ferromagnetic armatures, the windings being able to be excited by an excitation current.

Moreover, in the state of the art, there is no magnetic suspension for a gyroscopic actuator wheel of simple design that provides a response to the stresses explained hereinabove.

One aim of the invention is notably to overcome this absence of a known solution. The objectives and the choices assigned to the gyroscopic actuator according to the invention are such that certain characteristics must be observed in the design stage: thus, the wheel has a rigidity, stable or unstable, on each of its three axes, so as to compensate the weight of the rotor without requiring the provision of additional energy; then, the device comprises either an active thrust, that is to say a magnetic “abutment”, with which to control an axis, or an active centre finder with to control two axes; finally, in order to be able to compensate strong transverse torques, the gyroscopic actuator according to the invention includes a passive thrust on a large diameter or a passive centre finder distributed at at least two distanced points along the rotation axis.

### SUMMARY OF THE INVENTION

To this end, the subject of the invention is a gyroscopic actuator device comprising a magnetically suspended wheel which has one or two active axes and is mounted on a universal joint, said wheel having a rigidity on each of its three translation axes and comprising a body called rotor that is mobile about a rotation axis relative to a reference body; according to the invention, said gyroscopic actuator device comprises a thrust and a centre finder, the combination of which provides the magnetic suspension function, and in that said wheel has a rigidity along each of its axes such that it can be used:
to compensate the weight of the rotor and to make said wheel testable along any axis under gravity without consuming additional energy;
to transmit a gyroscopic torque without consuming additional energy.

In a preferred embodiment of the invention, said thrust is passive and has a radial rigidity, that is to say along an axis orthogonal to the rotation axis.

Advantageously, said centre finder has a radial rigidity, that is to say along an axis orthogonal to the rotation axis.

In an exemplary implementation of the invention, said centre finder is a polarized electromagnet.

In an exemplary embodiment of the invention, said centre finder has no radial rigidity, that is to say along an axis orthogonal to the rotation axis.

Said centre finder can, for example, be a centre finder with Laplace force.

Said centre finder can also be a non-polarized electromagnet.

### BRIEF DESCRIPTION OF THE DRAWINGS

Other features and benefits of the invention will become apparent from the following description, given in light of the appended drawings which represent:

FIG. 1: the diagram of a half-view in cross section of a first example of magnetic suspension for a gyroscopic actuator according to the invention, comprising a centre finder with polarized electromagnet;

FIG. 2: the diagram of a half-view in cross section of a second example of magnetic suspension for a gyroscopic actuator according to the invention, including a centre finder with Laplace force;

FIG. 3: the diagram of a half-view in cross section of a third example of magnetic suspension for a gyroscopic actuator according to the invention, including a centre finder with non-polarized electromagnet.

### DETAILED DESCRIPTION OF THE INVENTION

It is specified here that the exemplary implementations of the invention described with the help of the figures are not exhaustive and that the principle of the invention can be used with other centre finder and thrust configurations.

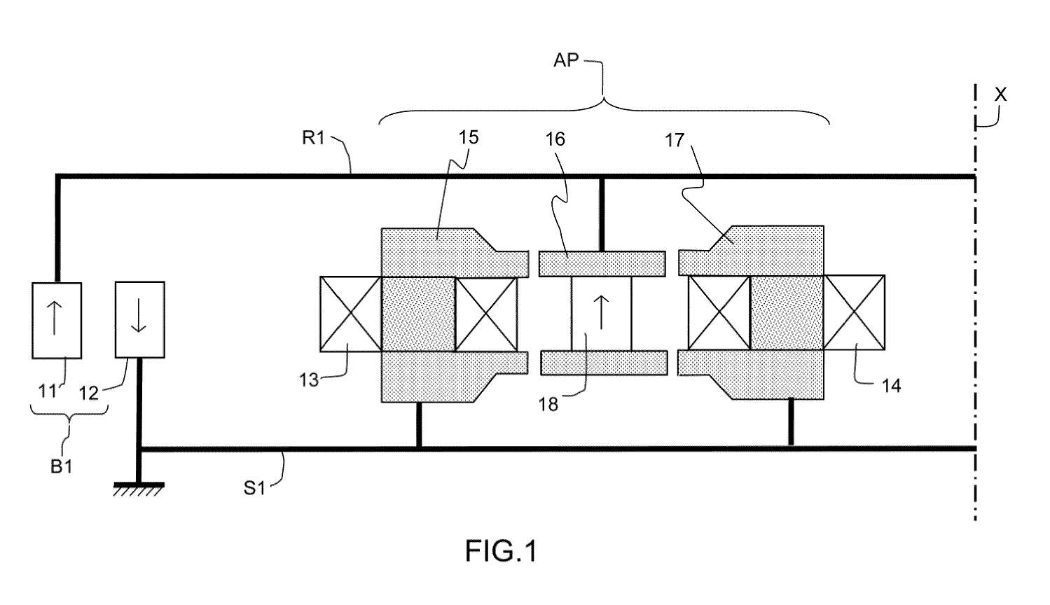

FIG. 1 shows a magnetic suspension diagram according to the invention through a simplified representation of a half-view in cross section of a gyroscopic actuator wheel. This is a first exemplary implementation of the device according to the invention. As has already been explained briefly, the purpose of the invention is to enable magnetically suspended gyroscopic actuators to be perfected that address three main criteria:
these gyroscopic actuators must have a wheel that can be tested along any axis under gravity, without the provision of additional energy;
they must have a minimum of active axes, or one or two axes to be controlled;
the magnetic suspension of the device must be capable of supporting very strong transverse torques.

Hereinafter in the present patent application, the case where the device comprises two axes to be controlled will be dealt with more particularly. Consequently, the terms “active centre finder” and “passive thrust” will apply. It should be noted that the explanations below will be transposable in the case where the device comprises a single axis to be controlled: the terms “centre finder” and “thrust” can simply be swapped over.

Observing the three criteria mentioned hereinabove implies technical constraints in the design of the magnetically suspended gyroscopic actuator according to the invention:
firstly, the testability of the wheel of the device along any axis, under gravity, and without consuming additional energy, makes the presence of a rigidity, whether stable or unstable, along the three axes of said wheel necessary, these three axes being the rotation axis about which the wheel revolves and the two axes orthogonal to this axis and contained within the plane of the wheel. This rigidity provides a way, in effect, of compensating the weight of the rotor via an offset of the latter;
then, the capacity to take up strong transverse torques requires the presence of passive thrust with magnets (or of a passive centre finder in the case of a device with a single axis to be controlled) on a large diameter of the wheel, said thrust being stable axially and in tilt, and unstable radially;
finally, the device according to the invention must include an active centre finder (or an active thrust in the case of a device with a single axis to be controlled), to compensate the instability of the thrust (or that of the centre finder).

In order to address the constraints explained hereinabove, the subject of the invention is a gyroscopic actuator comprising a wheel, with a rotor R1 that is mobile about a reference body, the stator S1. The rotor R1 revolves about the rotation axis X. The magnetic suspension comprises the combination of an active centre finder, in this case a centre finder with polarized electromagnet AP, and a passive thrust B1 with magnets 11, 12. The centre finder with polarized electromagnet AP is made up of magnetic bearings having ferromagnetic armatures 15, 16, 17, windings 13, 14, possibly redundant, and polarized magnets 18. The way this magnetic centre finder with polarized electromagnet AP operates is conventional: the polarized magnets 18 and the windings 13, 14, which can be excited by an excitation current, generate magnetic fluxes that circulate in the ferromagnetic armatures 15, 16, 17 and in the air gaps that separate them; these magnetic fluxes induce return or repulsion forces at the level of the air gaps and make it possible to actively control the two axes orthogonal to the axis X and contained within the plane of the magnetic bearings.

This first variant constitutes an exemplary embodiment of a magnetic suspension for a gyroscopic actuator wheel according to the invention.

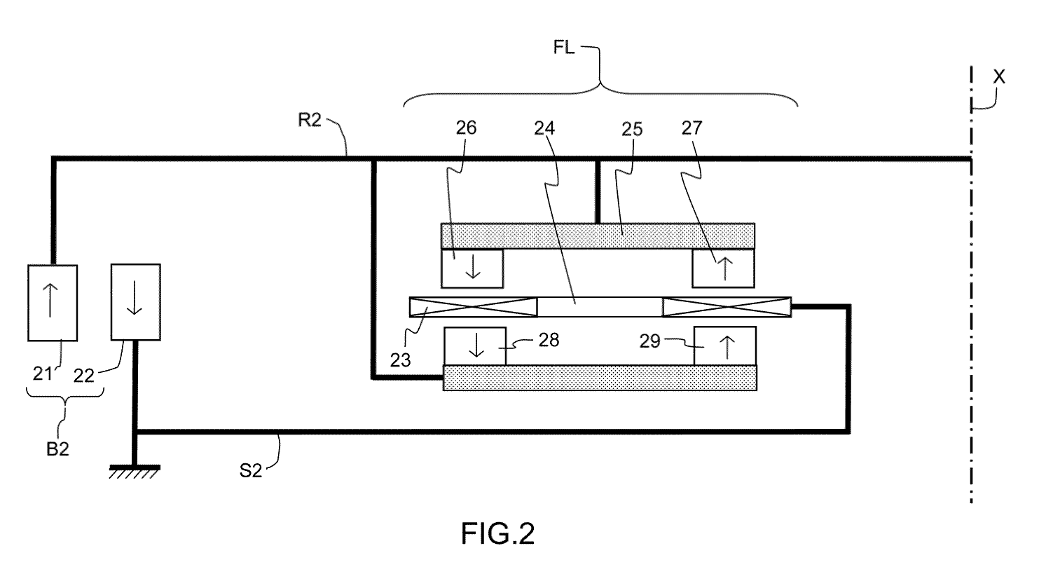

FIG. 2 illustrates a second exemplary implementation of the invention. In this example, the active centre finder associated with the passive thrust B2 with magnets 21, 22 is a centre finder with Laplace force FL.

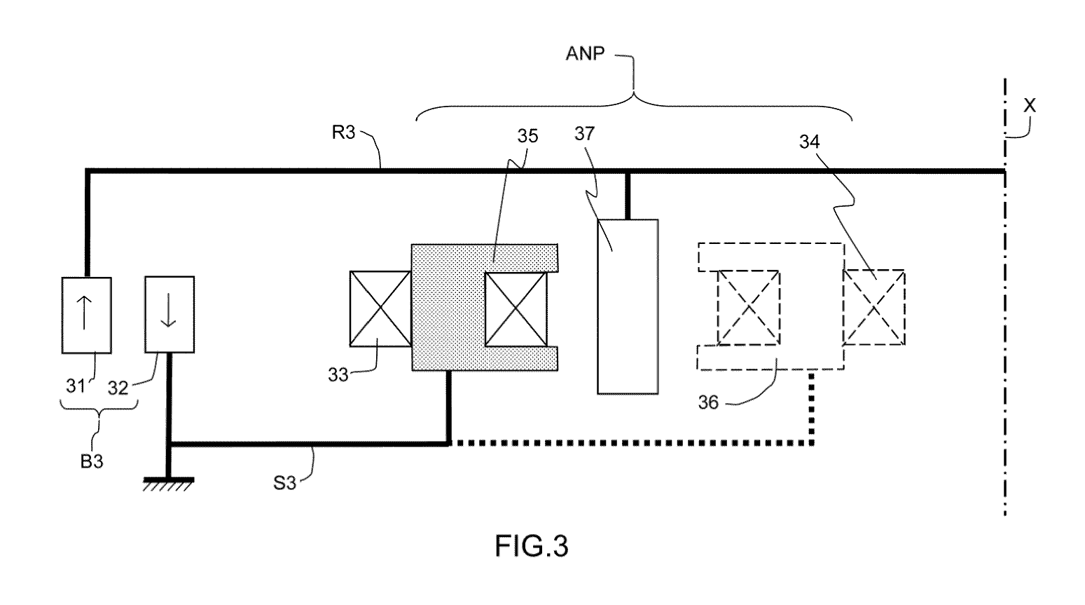

FIG. 3 represents a third and final exemplary implementation of the invention, in which the active centre finder associated with the passive thrust 3 with magnets 31, 32 is a centre finder with non-polarized electromagnet ANP.

The centre finder with Laplace force FL of FIG. 2 and the centre finder with non-polarized electromagnet ANP of FIG. 3 both have the particular feature of not including radial rigidity, that is to say rigidity along an axis orthogonal to the axis X and contained within the median plane of the centre finder, said median plane itself being orthogonal to the axis X. This point constitutes an advantage compared to the centre finder with polarized electromagnet AP of FIG. 1. In practice, the latter has an unstable radial rigidity which is added to that of the thrust B1. This overall rigidity has associated with it a resonance frequency directly impacting on the dimensioning of the bandwidth of the device. This frequency must be as low as possible, in order to be easily controllable. Furthermore, this resonance frequency linked to the radial instability of the device must in effect be decoupled from the rotation frequency of the rotor R1, which can have negative consequences on the performance characteristics of the device. The centre finders with Laplace force FL and with non-polarized electromagnet ANP do to have radial rigidity, this problem does not arrive because the overall radial rigidity is greatly reduced.

Thus, FIG. 2 shows a centre finder with Laplace force FL comprising ferromagnetic armatures 24, 25, a winding 23, possibly redundant, and polarized magnets 26, 27, 28, 29. The rotor R2 can revolve relative to the stator S2 about the rotation axis X and the centre finder with Laplace force FL controls the two axes orthogonal to the axis X.

As for FIG. 3, it represents a centre finder with non-polarized electromagnet ANP associated with a passive thrust B3 with magnets 31, 32. The centre finder with non-polarized electromagnet ANP comprises a winding 33, possibly redundant, ferromagnetic armatures 35 and non-polarized magnets 27, said centre finder possibly being doubled up within the non-polarized electromagnets 37 with other windings 34 associated with ferromagnetic armatures 36. Like the other devices, the latter comprises a rotor R3 that can revolve relative to the stator S3 about the rotation axis X. The centre finder with non-polarized electromagnet ANP can control the two axes orthogonal to the axis X.

It is recalled here that the three examples explained do not represent an exhaustive list of possibilities. Numerous variants regarding the magnetic bearings of the active centre finder or regarding the type of passive thrust are available, without in any way departing from the scope of the present invention. Thus, the thrust with magnets can have 1 to n pairs of magnets, said magnets being able to be magnetized axially or radially.

Furthermore, the air gaps of the thrust can be flat or cylindrical.

Regarding the magnetic centre finder with polarized magnet AP of FIG. 1, the latter can have windings inside and/or outside relative to the polarized magnets; the windings can be arranged on two stages, as in the French Patent Application FR 0707992; or the polarized magnets can even be located on the stator and not on the rotor.

Finally, the centre finder with non-polarized magnet of FIG. 3 can have windings inside and/or outside relative to the non-polarized magnets; the windings can be arranged vertically and not horizontally. Finally, as previously, the windings can be arranged on two stages.

To sum up, the main advantage of the invention is that it proposes a simple magnetically suspended gyroscopic actuator architecture. Said magnetic suspension is provided by the combination of an active centre finder and a passive thrust (or, conversely, of a passive centre finder and an active thrust). The gyroscopic actuator according to the invention has also been designed to enable the wheel that it includes to be tested on the ground, along any axis. In practice, the gyroscopic actuator device according to the invention consumes the same energy at each instant, regardless of the gyroscopic torque applied.

Moreover, it has a maximum of two active axes and it is capable of taking up strong transverse torques.

1. Gyroscopic actuator device comprising:
a magnetically suspended wheel which has at least one active axis and is rotatable mounted on a universal joint having a rotation axis, said wheel held rigidly in each of its three translation axes, the wheel comprising:
a rotor that is mobile about the rotation axis;
a reference body that is stationary with respect to the rotation axis;
a first magnet attached to the rotor, the first magnet having a predetermined polarization;
a second magnet attached to the reference body, the first magnet having a predetermined polarization that is different than the predetermined polarization of the first magnet, the first and second magnets together providing a thrust to the rotor; and
a center finder,
wherein:
the wheel is able to compensate for the weight of the rotor and to make said wheel testable along any axis under gravity without consuming additional energy; and
the wheel is able to transmit a gyroscopic torque without consuming additional energy.

2. Device according to claim 1, wherein said thrust is passive and holds the wheel rigid along an axis orthogonal to the rotation axis.

3. Device according to claim 1, wherein said center finder is radially rigid along an axis orthogonal to the rotation axis.

4. Device according to claim 3, wherein said center finder comprises a polarized electromagnet.

5. Device according to claim 1, wherein said center finder has no radial rigidity along an axis orthogonal to the rotation axis.

6. Device according to claim 5, wherein said center finder comprises a center finder with Laplace force.

7. Device according to claim 5, wherein said center finder comprises a non-polarized electromagnet.

8. Device according to claim 2, wherein said center finder is radially rigid along an axis orthogonal to the rotation axis.

9. Device according to claim 8, wherein said center finder comprises a polarized electromagnet.

10. Device according to claim 2, wherein said center finder has no radial rigidity along an axis orthogonal to the rotation axis.

11. Device according to claim 10, wherein said center finder comprises a center finder with Laplace force.

12. Device according to claim 10, wherein said center finder comprises a non-polarized electromagnet.
